(19) United States
(12) Patent Application Publication
(10) Pub. No.: US 2013/0048806 A1
(43) Pub. Date: Feb. 28, 2013

(54) Surface Aerator

(71) Applicants: Thomas J. Fandel, Gig Harbor, WA (US); Tamsyn Lyn Manning, Tacoma, WA (US)

(72) Inventors: Thomas J. Fandel, Gig Harbor, WA (US); Tamsyn Lyn Manning, Tacoma, WA (US)

(21) Appl. No.: 13/552,981

(22) Filed: Jul. 19, 2012

Related U.S. Application Data
(60) Provisional application No. 61/575,719, filed on Aug. 25, 2011.

(51) Int. Cl. A01G 9/00

(52) U.S. Cl. 248/188.8

(57) ABSTRACT

Disclosed, among other things, are ways to allow air to circulate under a plant pot or other object that may otherwise cause stains or rotting on a surface such as a deck or a hard surface floor. In one embodiment, height-adjustable wedges slip into inter-board spaces on a deck. A plant pot or other object is placed on the wedges and adjustable surfaces allow leveling of the plant pot. In another embodiment, a height-adjustable block may be placed on a hard surface to prevent damage to the object or the hard surface.

### RELATED APPLICATIONS

This application claims priority to provisional application 61/575,719 for “Wedgee, the Deck Airrator,” filed Aug. 25, 2011.

### FIELD

This disclosure relates to a Surface Aerator.

### BACKGROUND

Plant pots, planters, and other objects are often placed on decks for long periods of time. Decks may stain or rot when insufficient air circulation is available between objects and the deck.

Similar stains and rotting may also occur on other hard surfaces, such as concrete, granite, stones, or other natural or synthetic materials.

### SUMMARY OF THE INVENTION

The following presents a simplified summary of the disclosure in order to provide a basic understanding to the reader. This summary is not an extensive overview of the disclosure and it does not identify key/critical elements of the subject matter or delineate the scope of the claimed subject matter. Its sole purpose is to present some concepts disclosed herein in a simplified form as a prelude to the more detailed description that is presented later.

The instant application discloses, among other things, ways to allow air to circulate under a plant pot or other object that may otherwise cause stains or rotting. In one embodiment, height-adjustable wedges slip into inter-board spaces on a deck. A plant pot or other object is placed on the wedges and adjustable surfaces allow leveling of the plant pot. In another embodiment, a height-adjustable block may be placed on a hard surface, such as concrete, granite, stones, or other natural or synthetic materials to prevent damage to the object or the solid surface.

### BRIEF DESCRIPTION OF THE DRAWINGS

FIG. 1 is an example of Surface Aerators as used in a first embodiment.

FIG. 2 is a side view of a Surface Aerator according to one embodiment.

FIG. 3 is a front view of a Surface Aerator according to one embodiment.

FIG. 4 is a top view of a Surface Aerator according to one embodiment.

FIG. 5 is a side view of a Surface Aerator according to another embodiment.

FIG. 6 is a side view of a Surface Aerator according to yet another embodiment.

FIG. 7 is a top view of a Surface Aerator according to an embodiment.

Like reference numerals indicate like elements in the drawings. Elements in the drawings are not drawn to scale unless otherwise indicated.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example, however any alternative implementation which carries out the same or equivalent functions is intended to fall within the scope of the present invention.

The instant application discloses, among other things, ways to allow air to circulate under a plant pot or other object that may otherwise cause stains or rotting. In one embodiment, wedges slip into inter-board spaces on a deck. A plant pot or other object is placed on the wedges and adjustable surfaces allow leveling of the plant pot. In another embodiment, a block may be placed on a hard surface, such as concrete, granite, stones, or other natural or synthetic materials to prevent damage to the object or the hard surface.

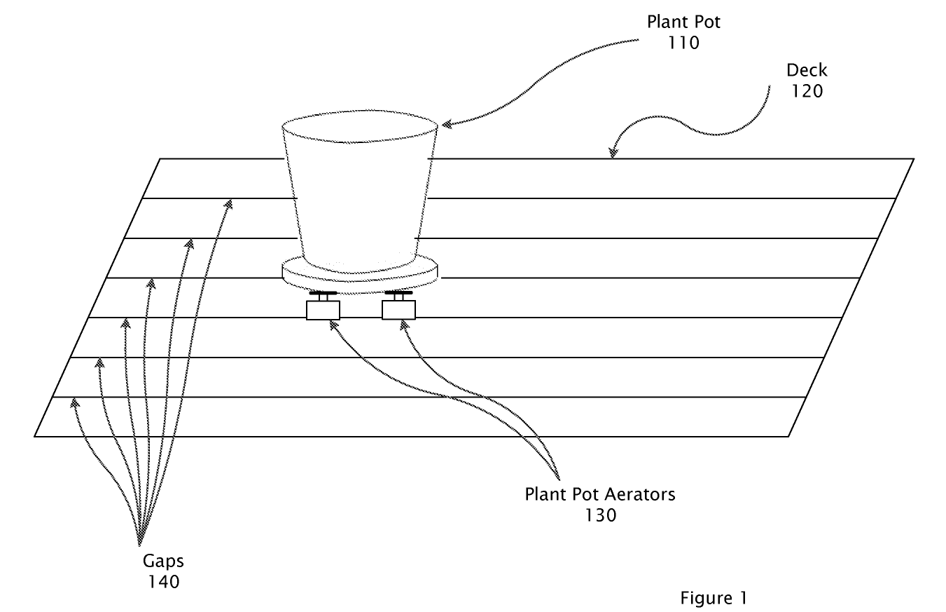

FIG. 1 is an example of Surface Aerators as used in one embodiment. Four Surface Aerators 130 (only two are visible in FIG. 1; in this example the other two are hidden by Plant Pot 110) may be inserted into Gaps 140 between boards on Deck 120, and may be adjusted to hold Plant Pot 110 level. This may prevent Deck 120 from staining or rotting due to moisture and other substances collected under Plant Pot 110.

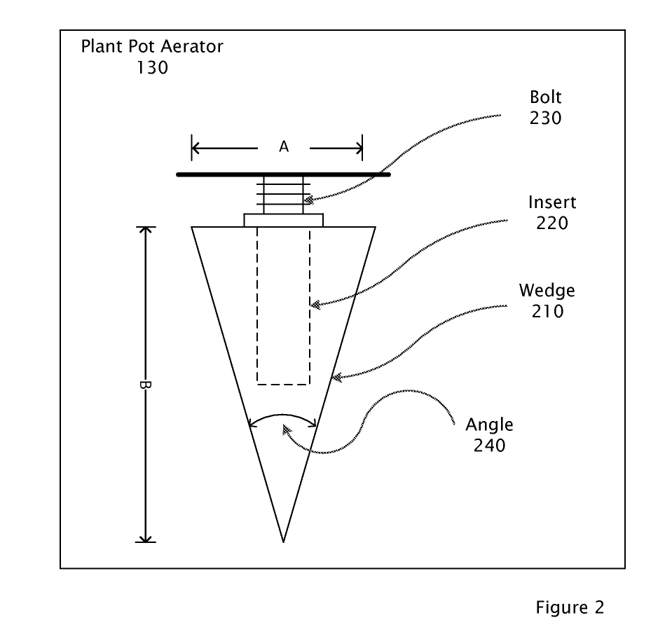

FIG. 2 is a side view of a Surface Aerator according to one embodiment. Wedge 210 may be made of high-density polyethylene (HDPE). In this embodiment, a side view of Wedge 210 forms an isosceles triangle with a base (A) of seven-eighths (⅞) inch. Height (B) is one and one-half (1½). Angle 240 may be approximately thirty (30) degrees, which may allow Wedge 210 to fit between in Gaps 140 while providing sufficient strength to support objects such as plant pots.

An Insert 220, which in this embodiment may provide a reinforced receptacle for a one-quarter (¼)-inch diameter bolt, threaded ¼-20 UNC (twenty threads per inch), may be placed into the base of the triangle and may be kept in place by adhesives, friction, gravity, or other ways as may be known in the art. Bolt 230 may be a one-quarter (¼)-inch diameter bolt, threaded ¼-20 UNC (twenty threads per inch) by one (1) inch nominal length, and may adjust in height from one-quarter (¼) to three-quarters (¾) of an inch above the Wedge 210 by screwing Bolt 230 in or out of Insert 220. In other embodiments, Bolt 230 may be a different diameter or length. Insert 220 is shown dashed because it is inside Wedge 210 and would not be visible in this view. One having skill in the art will recognize that other bolt sizes and other techniques to allow a height adjustment may be used, including but not limited to threading the wedge itself, placing a nut into a recess in the base of Wedge 210, or using a self-leveling device such as a spring.

Bolt 230 may have a wide flat head to facilitate it being used as a foot to hold a plant pot or other object.

Insert 220 and Bolt 230 may be made of zinc-coated steel, stainless steel, or any other material providing sufficient strength and durability in the weather conditions expected for the location it is to be used.

While the illustrated embodiment used a Wedge 210 made of HDPE, other embodiments may use other materials of appropriate strength and durability, such as ultra-high-molecular-weight (UHMW) polyethylene plastic, a corrosion-resistant metal such as stainless steel, or other material having sufficient strength and corrosion-resistance. One having skill in the art will also recognize that Wedge 210 may have different dimensions in base, height and angle than in the example embodiment shown.

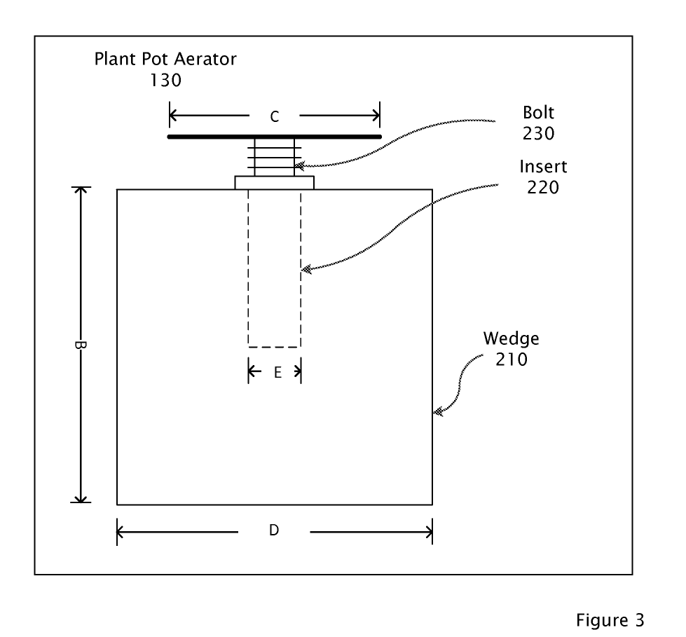

FIG. 3 is a front view of a Surface Aerator according to one embodiment. In this view, Bolt 230 is shown as having a flat, wide head (C); in this embodiment one (1) inch wide. In this embodiment, Wedge 210 (D) is one and three-sixteenths (1 3/16) inches wide. Insert 220 is shown dashed because it is inside Wedge 210 and would not be visible in this view. Insert 220 may have a diameter (E) appropriately sized based on Bolt 230; in this example approximately three-eighths (⅜) inch. In other embodiments, Wedge 210, Bolt 230, or Insert 220 may have different dimensions.

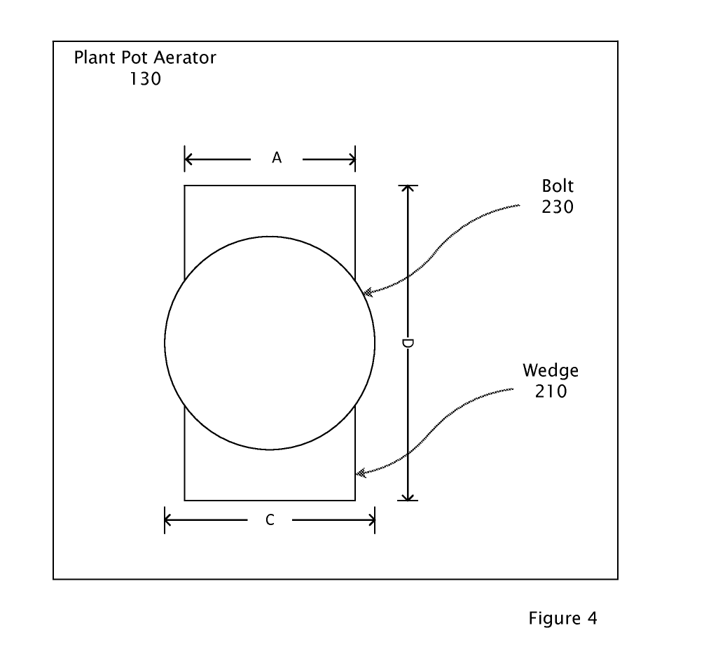

FIG. 4 is a top view of a Surface Aerator according to one embodiment. The head of Bolt 230 may be coated in plastic, which may improve longevity, stability, and friction with the object it may hold.

While this example has used an Insert 220 to hold Bolt 230, one skilled in the art will recognize that in other embodiments other techniques may be used. As an example and not a limitation, one embodiment may have threading directly in Wedge 210, while another may have a nut attached to Wedge 210.

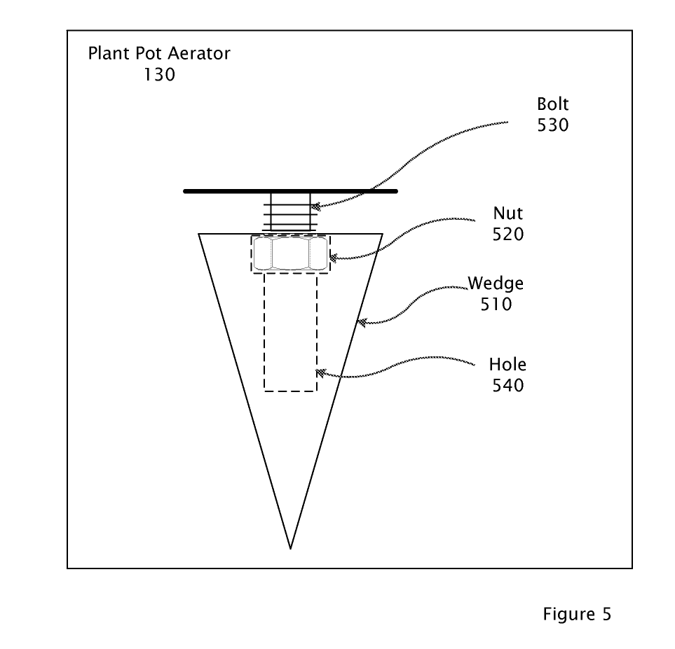

FIG. 5 is a side view of a Surface Aerator according to another embodiment. Wedge 510 may be made of high-density polyethylene (HDPE).

In this embodiment, a Hex Nut 520, which may provide a reinforced receptacle for a one-quarter (¼) inch bolt, may be placed into the base of the triangle and may be kept in place by adhesives, friction, gravity, or other ways as may be known in the art. Bolt 530 may be a one-quarter (¼)-inch diameter bolt, threaded ¼-20 UNC (twenty threads per inch) by one (1) inch nominal length, and may adjust in height from one-quarter (¼) to three-quarters (¾) of an inch above the Wedge 510 by screwing Bolt 530 in or out of Nut 520. In other embodiments, Bolt 530 may be a different diameter or length. Nut 520 is shown dashed because it is inside Wedge 510 and would not be visible in this view. One having skill in the art will recognize that other bolt sizes and other techniques to allow a height adjustment may be used, including but not limited to creating internal threads into Wedge 510 itself, placing an insert into the base of Wedge 510, or using a self-leveling device such as a spring.

Bolt 530 may have a wide flat head to facilitate it being used as a foot to hold a plant pot or other object.

Nut 520 and Bolt 530 may be made of zinc-coated steel, stainless steel, or any other material providing sufficient strength and durability in the weather conditions expected for the location it is to be used.

While the illustrated embodiment used a Wedge 510 made of HDPE, other embodiments may use other materials of appropriate strength and durability, such as ultra-high-molecular-weight (UHMW) polyethylene plastic, a corrosion-resistant metal such as stainless steel, or other material having sufficient strength and corrosion-resistance.

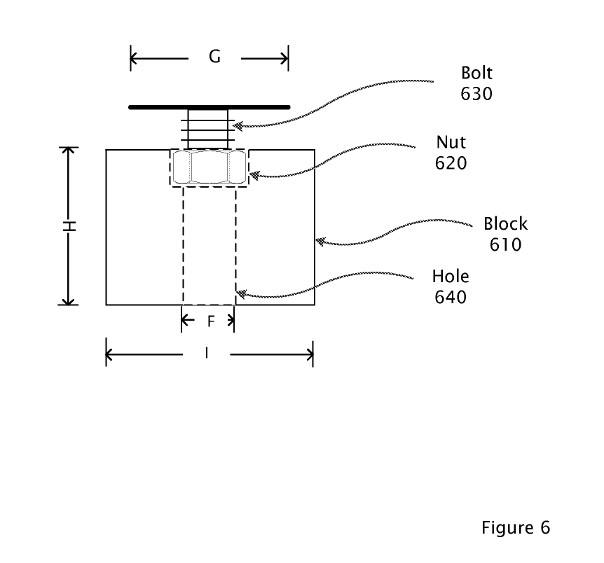

FIG. 6 is a side view of a Surface Aerator according to yet another embodiment. In this embodiment a cuboid-shaped Block 610 approximately (I) one and three-sixteenths (1 3/16) inch by (J) one and three-sixteenths (1 3/16) inch by (H) three-quarter (¾) inches may be used. A recess in a top surface of Block 610 may snugly hold a hex Nut 620, sized to couple with Bolt 630. In this embodiment, Bolt 630 may be (F) one-quarter (¼)-inch diameter bolt, threaded ¼-20 UNC (twenty threads per inch) by three-quarter (¾) inches nominal length. Bolt 630 may have a flat head approximately (G) three-quarters (¾) inches in diameter.

One having skill in the art will recognize that the dimensions in other embodiments may vary from those illustrated in this example.

While the illustrated embodiment used a Block 610 made of HDPE, other embodiments may use other materials of appropriate strength and durability, such as ultra-high-molecular-weight (UHMW) polyethylene plastic, a corrosion-resistant metal such as stainless steel, or other material having sufficient strength and corrosion-resistance.

Hole 640 may go partially or all the way through Block 610, which may allow Bolt 630 to be adjusted over a broader range. Hole 640 is shown dashed because it would not be visible in this view. Hole 640 may be appropriately sized (F) for Bolt 630 to fit through.

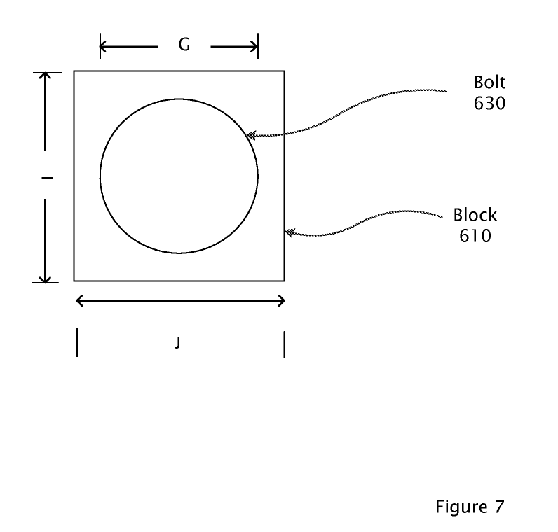

FIG. 7 is a top view of a Surface Aerator according to an embodiment. Bolt 630 may have a wide, flat head to facilitate it being used as a foot to hold a plant pot or other object. The head of Bolt 630 may be coated in plastic, which may improve longevity, stability, and friction with the object it may hold.

While these examples have been illustrated as having certain dimensions, other sizes may be used in other embodiments. These examples have also used a bolt as an adjustable foot; in another embodiment a foot may be fixed rather than adjustable, or may have a swiveling head to allow for curved or uneven surfaces. In yet another embodiment, a wedge or block may be used without a foot at all. In yet another embodiment, a foot may be spring-loaded and may automatically adjust in height to provide stability.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention.

1. A device, comprising:
a wedge having a narrow end and a wide end, an inside angle at the narrow end being approximately 30 degrees;
a foot approximately parallel with a surface on the wide end of the wedge coupled to the wedge by a coupling means, the coupling means allowing for an adjustment of the distance between the surface of the wedge and the foot.

2. The device of claim 1 wherein the wedge is made of a plastic.

3. The device of claim 1 wherein the wedge is made of metal or wood.

4. The device of claim 1 wherein the wedge is approximately between one and two inches in height.

5. The device of claim 1 wherein the surface of the wide end has a length of between one and two inches and a width of between one-half and one inch.

6. The device of claim 1 wherein coupling means comprises a screw actuating means.

7. The device of claim 4 wherein the screw actuating means comprises a bolt having a screw axis and a metal insert in the wedge, the insert including a threaded aperture communicating with the exterior and having a screw axis generally perpendicular to the surface of the wide end.

8. The device of claim 4 wherein the screw actuating means comprises a bolt having a screw axis and a threaded aperture communicating with the exterior and having a screw axis generally perpendicular to the surface of the wide end.

9. The device of claim 4 wherein the screw actuating means comprises a bolt having a screw axis and a hex nut coupled to the wedge, communicating with the exterior and having a screw axis generally perpendicular to the surface of the wide end.

10. A device, comprising:
a cuboid-shaped block having a top surface;
a foot approximately parallel with the top surface coupled to the block by a coupling means.

11. The device of claim 1 wherein the block is made of high-density polyethylene.

12. The device of claim 1 wherein the block is made of a corrosion-resistant metal.

13. The device of claim 1 wherein a height of the block is between one-half inch and one and one-half inches.

14. The device of claim 1 wherein the top surface of the block has a length of between one and two inches and a width of between one-half and one inch.

15. The device of claim 1 wherein coupling means comprises a screw actuating means, allowing an adjustment of a distance between the surface of the block and the foot.

16. The device of claim 4 wherein the screw actuating means comprises a bolt having a screw axis and a metal insert in the block, the insert including a threaded aperture communicating with the exterior and having a screw axis generally perpendicular to the surface of the top surface.

17. The device of claim 4 wherein the screw actuating means comprises a bolt having a screw axis and a threaded aperture communicating with the exterior and having a screw axis generally perpendicular to the top surface of the block.

18. The device of claim 4 wherein the screw actuating means comprises a bolt having a screw axis and a hex nut coupled to the block, communicating with the exterior and having a screw axis generally perpendicular to the top surface of the block.
